(19) United States
(12) Patent Application Publication
(10) Pub. No.: US 2026/0344590 A1
(43) Pub. Date: Nov. 5, 2026

(54) IRRIGATION SPRINKLER DEBRIS FLUSHING

(71) Applicant: IrriGreen, Inc., Edina, MN (US)

(72) Inventors: Ted M. Hoffman, Eden Prairie, MN (US); Evan Pastor, Plymouth, MN (US)

(21) Appl. No.: 19/194,600

(22) Filed: Apr. 30, 2025

(51) Int. Cl. A01G 25/02; A01G 25/16

(52) U.S. Cl. CPC A01G 25/02; A01G 25/16

(57) ABSTRACT

An irrigation sprinkler includes a housing and a riser. The housing includes a base having a water input port and a pedestal having a central axis and an annular guide having a post opening at a distal end. The riser moves along the central axis and through the post opening between lowered and raised positions. The riser includes a water receiver and a tubular section that supports one or more nozzles. A first gap extending through the post opening between the tubular section and the annular guide decreases as the riser moves along the central axis through the post opening from the lowered position toward the raised position, and a fluid pathway extends from the water input port of the base through the first gap as the riser moves between the lowered position toward the raised position.

### FIELD

Embodiments of the invention relate to irrigation sprinklers and, more particularly, to sprinkler designs that facilitate flushing operations that flush debris from the sprinkler and/or prevent debris from entering the sprinkler.

### BACKGROUND

Irrigation systems commonly utilize in-ground rotary sprinklers equipped with pop-up sprinkler heads, which are conventionally referred to as the “riser”. During a watering operation, a water flow is supplied to the sprinkler, which drives the riser to an extended position, which positions a nozzle head supported by the riser above the surrounding ground level (grade), allowing for an unobstructed discharge of water from the nozzle head over the adjacent vegetation. At the end of the watering operation, the water flow is terminated, which drives the riser to a retracted position within a housing of the sprinkler, such that the top of the riser aligns flush with the ground surface. This design reduces trip hazards, prevents damage from lawn mowers, and maintains a visually appealing landscape.

Each time the riser moves between the extended and retracted positions, sand, dirt, or other debris from the surrounding soil may move into a gap between the riser and the below-grade portion of the sprinkler housing. The debris may accumulate over time and cause the riser to bind or stick to the housing. This binding of the riser prevents it from fully retracting and/or extending, creating a potential safety hazard, risking mechanical damage to the sprinkler, making the sprinkler susceptible to damage from contact from a lawn care vehicle (e.g., lawn mower, etc.), and/or compromising the irrigation system's performance.

Conventional in-ground irrigation sprinklers incorporate methods to address this debris infiltration problem. One prevalent strategy is the use of a flexible wiper seal at the top of sprinkler housing, which slides along the exterior of the riser as the riser retracts into the housing to remove sand or dirt from the riser. The effectiveness of such wiper seals is limited and deteriorates over time as the wiper seal wears out.

In-ground sprinklers may also employ protective covers or integrated filters around the riser, but these can clog quickly if the surrounding soil is particularly sandy or silty.

Some in-ground sprinklers have a self-flushing design, in which a portion of the water flow is initially directed along the exterior of the riser as the riser is transitioned from the retracted position to the extended position. However, conventional self-flushing designs do not provide a long term solution in a variety of different soil types resulting in debris infiltration and riser binding with the housing.

### SUMMARY

Embodiments of the present disclosure relate to pressure sensing in an irrigation sprinkler and include irrigation sprinklers having a pressure sensor, methods of operating the irrigation sprinklers and methods of assembling the irrigation sprinklers.

One example of the irrigation sprinkler includes a housing and a riser. The housing includes a base having a water input port and a pedestal having a central axis and including a proximal end attached to the base and a distal end comprising an annular guide having a post opening. The riser is configured to move along the central axis between a lowered position and a raised position relative to the pedestal and extend through the post opening. The riser includes a water receiver at a proximal end of the riser, a tubular section extending along the central axis between the water receiver and a distal end of the riser, and one or more nozzles supported at the distal end of the riser. A first gap extending through the post opening between the tubular section and the annular guide decreases as the riser moves along the central axis through the post opening from the lowered position toward the raised position, and a fluid pathway extends from the water input port of the base through the first gap as the riser moves between the lowered position toward the raised position.

In some embodiments, the tubular section has a diameter that tapers from a first diameter near the water receiver to a second diameter near the distal end that is smaller than the first diameter.

In some embodiments, the sprinkler includes a rotatable support that is configured to rotate about the central axis relative to the base and the riser rotates about the central axis with the rotatable support. The water receiver of the riser slides within the rotatable support along the central axis as the riser moves between the lowered and raised positions. The fluid pathway extends through a second gap between the water receiver and the rotatable support.

In some embodiments, the annular guide includes a top side and a bottom side, the post opening extends from the top side to the bottom side, a deflector at the top side defines a minimum diameter of the post opening, and a diameter of the post opening increases with displacement along the central axis toward the bottom side from the deflector.

In some embodiments, the sprinkler includes an O-ring that is supported on the riser at a junction between the tubular section and the water receiver. The O-ring is configured to form a seal with a bottom portion at the bottom side of the annular guide when the riser is in the raised position that closes the fluid pathway.

In some embodiments, the deflector includes an interior surface oriented at a first acute angle relative to the central axis and a top surface, the first gap is defined by the interior surface of the deflector and an exterior surface of the tubular section, and the annular guide includes a central portion between the deflector and the bottom side having an interior surface oriented at a second acute angle relative to the central axis that is less than the first acute angle.

In some embodiments, the deflector includes a top exterior surface oriented at a third acute angle relative to the central axis configured to deflect material away from the tubular section and the central axis as the riser moves from the raised position toward the lowered position.

In some embodiments, the central portion includes an exterior surface extending from the top exterior surface of the deflector and oriented at a fourth acute angle relative to the central axis, which is less than the third acute angle, the exterior surface of the central portion configured to deflect material received from the top exterior surface away from the tubular section and the central axis.

In some embodiments, the riser includes a cap at the distal end that extends radially from the central axis. The cap covers the post opening and the deflector when the riser is in the lowered position. A bottom surface of the cap engages an exterior surface of the annular guide at a location that is displaced radially from the central axis a distance that is greater than a distance from the central axis to the deflector when the riser is in the lowered position.

In some embodiments, the location at which the bottom surface of the cap engages the exterior surface of the annular guide is displaced along the central axis toward the bottom side of the annular guide from the post opening.

In one embodiment of a method of operating an irrigation sprinkler, the irrigation sprinkler includes a housing and a riser. The housing includes a base having a water input port and a pedestal having a central axis and including a proximal end attached to the base and a distal end comprising an annular guide having a post opening. The riser is configured to move along the central axis between a lowered position and a raised position relative to the pedestal and extend through the post opening. The riser includes a water receiver at a proximal end of the riser, a tubular section extending along the central axis between the water receiver and a distal end of the riser and one or more nozzles supported at the distal end of the riser. A gap extending through the post opening between the tubular section and the annular guide decreases as the riser moves along the central axis through the post opening from the lowered position toward the raised position. In the method, the riser is moved from the lowered position toward the raised position and the gap is increased in response to receiving a water flow at the water receiver from the water input port. A first water flow portion of the water flow is delivered through the tubular section and the one or more nozzles. A second water flow portion of the water flow is delivered through a sprinkler flush pathway that extends between the tubular section and the pedestal and through the gap during movement of the riser. Debris in the sprinkler flush pathway is flushed through the post opening using the second water flow portion.

In some embodiments, the tubular section has a diameter that tapers from a first diameter near the water receiver to a second diameter near the distal end that is smaller than the first diameter.

In some embodiments, the annular guide includes a top side and a bottom side and the post opening extends from the top side to the bottom side. A deflector at the top side of the annular guide defines a minimum diameter of the post opening and a diameter of the post opening increases with displacement along the central axis toward the bottom side from the deflector. The method includes narrowing the gap in response to moving the riser.

In some embodiments, the sprinkler includes an O-ring that is supported on the riser at a junction between the tubular section and the water receiver, and the method includes closing the sprinkler flush pathway through a seal formed between a bottom portion of the annular guide and the O-ring when the riser reaches the raised position.

In some embodiments, the deflector includes an interior surface oriented at a first acute angle relative to the central axis and a top surface, the gap is defined by the interior surface of the deflector and an exterior surface of the tubular section, and the annular guide includes a central portion between the deflector and the bottom side having an interior surface oriented at a second acute angle relative to the central axis that is less than the first acute angle.

In some embodiments, the deflector includes a top exterior surface oriented at a third acute angle relative to the central axis. The method includes reducing a flow rate of the water flow, moving the riser toward the lowered position, and deflecting debris and water away from the tubular section and the central axis at the top exterior surface of the deflector during moving the riser toward the lowered position.

In some embodiments, the central portion of the annular guide includes an exterior surface extending from the top exterior surface of the deflector and oriented at a fourth acute angle relative to the central axis, which is less than the third acute angle, and the method includes deflecting debris and water away from the tubular section and the central axis at the exterior surface of the central portion during moving the riser toward the lowered position.

In some embodiments, the riser includes a cap at the distal end that extends radially from the central axis. The cap covers the post opening and the deflector when the riser is in the lowered position. A bottom surface of the cap engages an exterior surface of the annular guide at a location that is displaced radially from the central axis a distance that is greater than a distance from the central axis to the deflector when the riser is in the lowered position.

In some embodiments, the location at which the bottom surface of the cap engages the exterior surface of the annular guide is displaced along the central axis toward the bottom side of the annular guide from the post opening.

In some embodiments, the method includes reducing a flow rate of the water flow, moving the riser toward the lowered position, delivering the second water flow portion through the sprinkler flush pathway, stopping the water flow, moving the riser to the lowered position in response to stopping the water flow and closing the sprinkler flush pathway through a seal formed between the bottom surface of the cap and the exterior surface of the annular guide when the riser is in the lowered position.

In another embodiment of a method of operating an irrigation sprinkler, the irrigation sprinkler includes a housing and a riser. The housing includes a base having a water input port and a pedestal having a central axis and including a proximal end attached to the base and a distal end comprising an annular guide having a post opening. The riser is configured to move along the central axis between a lowered position and a raised position relative to the pedestal and extend through the post opening. The riser includes a water receiver at a proximal end of the riser, a tubular section extending along the central axis between the water receiver and a distal end of the riser, and one or more nozzles supported at the distal end of the riser. A gap extending through the post opening between the tubular section and the annular guide increases as the riser moves along the central axis through the post opening from the raised position toward the lowered position. In the method, the riser is moved from the raised position toward the lowered position and the gap is increased in response to decreasing a water flow received at the water receiver from the water input port. A portion of the water flow is delivered through a sprinkler flush pathway that extends between the tubular section and the pedestal and through the gap during the movement of the riser. Debris in the sprinkler flush pathway is flushed through the post opening using the portion of the water flow.

In one embodiment, the riser includes a cap at the distal end that extends radially from the central axis, and the cap covers the post opening and the deflector when the riser is in the lowered position. In the method, the water flow is stopped, and the riser is moved to the lowered position. An exterior surface of the annular guide engages a bottom surface of the cap at a location that is displaced along the central axis toward the annular guide from the post opening, and displaced radially from the central axis a distance that is greater than a distance from the central axis to the deflector.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a schematic diagram of an example of an irrigation sprinkler, in accordance with embodiments of the present disclosure

FIGS. 2 and 3 are isometric views of an example of an in-ground version of the sprinkler, in accordance with embodiments of the present disclosure.

FIG. 4 is a side cross-sectional view of the example sprinkler of FIG. 2 taken generally along line 4-4, in accordance with embodiments of the present disclosure.

FIG. 5 is a simplified diagram of an example of a controller, in accordance with embodiments of the present disclosure.

FIG. 6 is a cross-sectional view of an example irrigation sprinkler, in which a riser is in a raised position, in accordance with embodiments of the present disclosure.

FIG. 7 is a cross-sectional view of an example irrigation sprinkler, in which a riser is positioned between lowered and raised positions, in accordance with embodiments of the present disclosure.

FIGS. 8-10 respectively are a partial cross-sectional view of an irrigation sprinkler near an annular guide, a simplified close-up view of FIG. 8 taken within circle 9, and a simplified close-up view of FIG. 8 taken within circle 10, in accordance with embodiments of the present disclosure.

FIG. 11 is a partial cross-sectional view of an irrigation sprinkler near an annular guide when a riser is in a fully raised position, in accordance with embodiments of the present disclosure.

FIG. 12 is a simplified close-up view of the sprinkler of FIG. 11 taken within circle 12, in accordance with embodiments of the present disclosure.

FIG. 13 is a partial cross-sectional view of an example sprinkler near an annular guide when a riser is near a lowered position, in accordance with embodiments of the present disclosure.

FIG. 14 is a simplified close-up view of FIG. 13 taken within circle 14, in accordance with embodiments of the present disclosure.

FIG. 15 is a partial cross-sectional view of an example sprinkler near an annular guide when a riser is in a lowered position, in accordance with embodiments of the present disclosure.

FIG. 16 is a simplified close-up view of FIG. 15 taken within circle 16, in accordance with embodiments of the present disclosure.

FIG. 17 is a flowchart illustrating an example of a method of operating an irrigation sprinkler, in accordance with embodiments of the present disclosure.

FIG. 18 is a flowchart illustrating an example of a method of operating an irrigation sprinkler, in accordance with embodiments of the present disclosure.

### DETAILED DESCRIPTION OF ILLUSTRATIVE EMBODIMENTS

Embodiments of the present disclosure, which are described more fully hereinafter with reference to the accompanying drawings, relate to pressure sensing in an irrigation sprinkler and include irrigation sprinklers having a pressure sensor, methods of operating the irrigation sprinklers and methods of assembling the irrigation sprinklers. Elements that are identified using the same or similar reference characters refer to the same or similar elements. The various embodiments of the present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art.

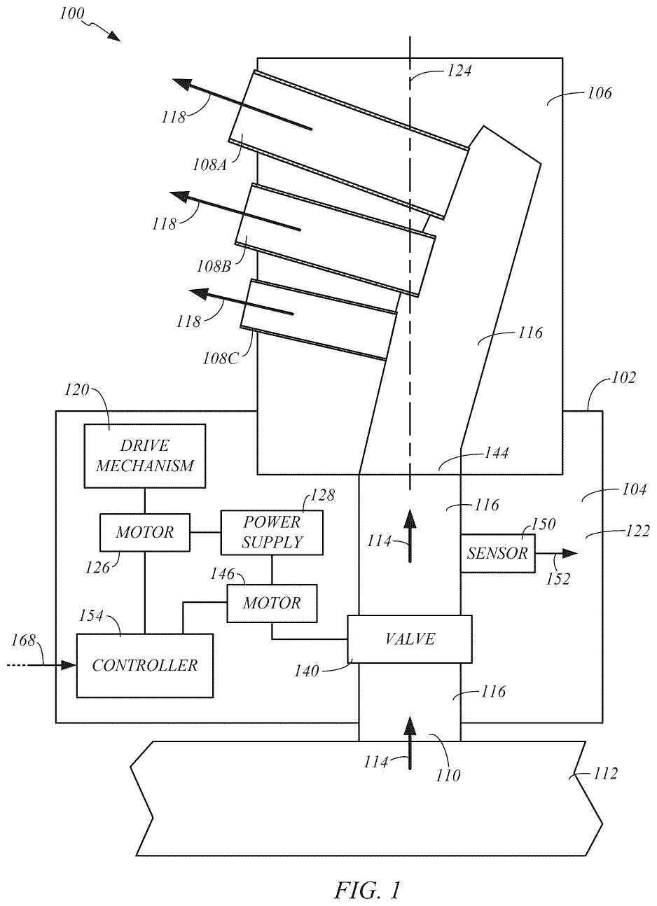

FIG. 1 is a schematic diagram of an example of an irrigation sprinkler 100, in accordance with embodiments of the present disclosure. The example sprinkler 100 generally comprises a housing 102 including a base 104, which supports a nozzle head 106 that includes one or more nozzles 108, such as nozzles 108A-C.

The base 104 includes a water supply input port 110 that may be coupled to a water supply line 112, such as a hose or in-ground piping. The water supply line 112 provides a pressurized source of water that supplies a water flow 114 to the nozzles 108 through a fluid flow path 116 of the sprinkler 100 that extends from the input port 110 to the nozzle head 106 where the water flow 114, or at least a portion thereof, is discharged through the one or more nozzles 108 as one or more watering streams 118.

In one embodiment, the sprinkler 100 includes a drive mechanism 120, which is supported within a main chamber 122 of the base 104 and is configured to drive rotation of the nozzle head 102 about a vertical axis 124 relative to the base 104, in accordance with conventional sprinklers. In one example, the drive mechanism 120 comprises a motor 126, such as an electric motor (e.g., stepper motor, or a motor with an encoder) or a hydraulic motor that drives the rotation of the nozzle head 102 relative to the base 104 through a suitable gear arrangement. The motor 126 may be powered using a suitable power supply 128, such as a battery or line power received from a main control box through a power line, for example.

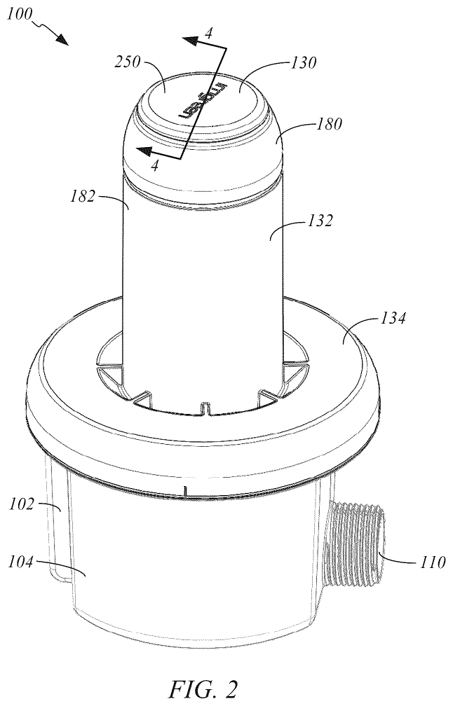

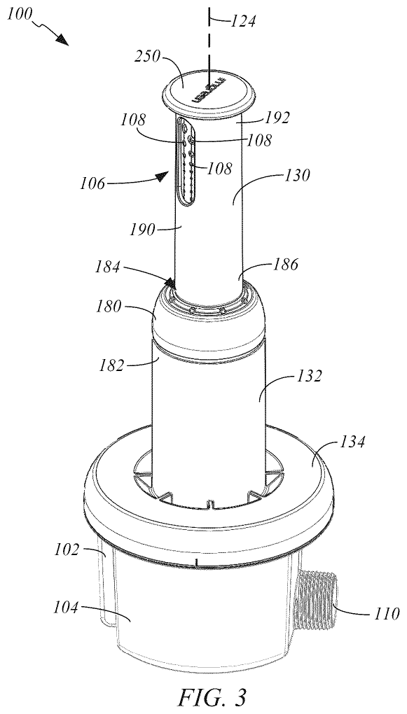

The sprinkler 100 may be an in-ground sprinkler design, in which the housing 102 may be buried within the ground. FIGS. 2 and 3 are isometric views of an example of an in-ground version of the sprinkler 100, in accordance with embodiments of the present disclosure. The nozzle head 106 may be supported on a rotatable riser 130 having a lowered position, in which the riser 130 is retracted into a pedestal 132 of the housing 102 that is supported by the base 104, as shown in FIG. 2, and a raised position, in which the riser 130 is generally extended from the pedestal 132 for performing a watering operation, as shown in FIG. 3. The pedestal 132 may be supported by a housing cap 134 that seals an opening to the main chamber 122 of the base 104.

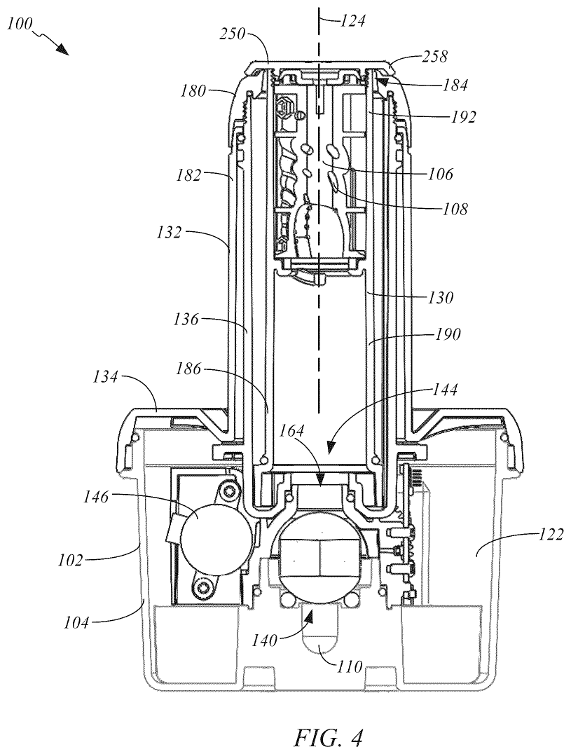

FIG. 4 is a side cross-sectional view of the example sprinkler 100 of FIG. 2 taken generally along line 4-4, in accordance with embodiments of the present disclosure. The riser 130, which is shown in the lowered position, may be supported within a rotatable support 136 that may be rotated about the central axis 124 using the drive mechanism 120 (FIG. 1). Rotation of the rotatable support 136 by the drive mechanism 120 drives rotation of the riser 130 about the axis 124.

In one embodiment, the sprinkler 100 includes a valve 140 within the main chamber 122 that controls the water flow 114 through the fluid flow path 116 to the nozzle head 106, as shown in FIG. 1. The valve 140 may take on any suitable form, such as a ball valve, a solenoid valve, or another suitable valve. In one embodiment, the valve 140 has a closed position, in which water is blocked by the valve 140 from flowing through the fluid flow path 116 to the nozzle head 106, and an open position, in which the water flow 114 or at least a portion thereof, travels through the valve 140 and the fluid flow path 116 to an inlet or water receiver 144 of the riser 130.

For the in-ground sprinkler 100, when the valve 140 is open, a portion of the water flow 114 drives movement of the riser 130 along the central axis 124 relative to the rotatable support 136 and the pedestal 132 to the raised position (FIG. 3) and is delivered to the nozzle head 106 where it is discharged through the one or more nozzles 108 as water streams 118 in a radial direction relative to the central axis 124. When the valve 140 is closed, the inlet or water receiver 144 of the riser 130 is fluidically disconnected from the input port 110, which terminates the water flow 114 through the fluid flow path 116. The resulting lack of water pressure at the inlet 144 causes the riser 130 to return to the lowered position (FIG. 2). The movement of the riser 130 to the lowered position may be driven using a suitable biasing mechanism, such as a spring.

The valve 140 also includes intermediary positions between the fully opened and fully closed positions that allow the flow rate of the water flow 114 through the fluid flow path 116 to be adjusted. As a result, the valve 140 may be used to adjust the flow rate of the water flow 114 and the distance the water streams 118 are discharged from the nozzle head 106. The position of the valve 140 may be controlled by an electric motor 146. The motor 146 may be a stepper motor, a motor with an encoder, a servo motor, or another suitable electric motor or device that may be used to adjust the position or state of valve 140.

In some embodiments, the sprinkler 100 includes a pressure sensor 150 that senses or measures a pressure within the fluid flow pathway 114 and produces a pressure signal 152 that is representative of the sensed pressure. A controller 154 of the sprinkler 100, which may be contained in the main chamber 122, uses the pressure signal 152 to set the position or state of the valve 140 such that the water streams 118 are discharged from the nozzle head 106 a desired distance for a given angular position of the nozzle head 106 about the central axis 124. This allows the sprinkler 100 to discharge the water streams 118 a variable distance as the nozzle head 106 is rotated about the axis 124 and perform a watering operation over a non-circular watering area.

The controller 154 may represent one or more controllers and/or circuitry that is used to perform functions described herein. The controller 154 may be contained within the main chamber 122 of the base 104 or located remotely from the sprinkler 100.

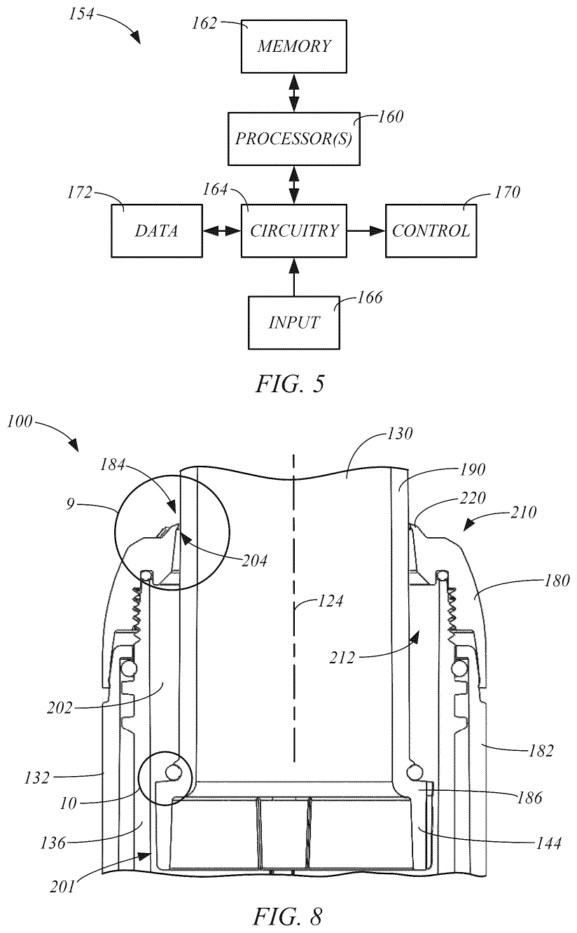

FIG. 5 is a simplified diagram of an example of the controller 154 in accordance with embodiments of the present disclosure. The controller 154 may include one or more processors 160 and memory 162, which may be local memory or memory that is accessible to the controller 154. The one or more processors 160 are configured to perform various functions described herein in response to the execution of instructions contained in the memory 162, such as a test program, for example.

The one or more processors 160 may be components of one or more computer-based systems, and may include one or more control circuits, microprocessor-based engine control systems, and/or one or more programmable hardware components, such as a field programmable gate array (FPGA). The memory 162 represents local and/or remote memory or computer-readable media. As used herein, such memory 162 comprises any suitable patent subject matter eligible computer-readable media and does not include transitory waves or signals. Examples of the memory 162 include conventional data storage devices, such as hard disks, CD-ROMs, optical storage devices, magnetic storage devices and/or other suitable data storage devices. The controller 154 may include circuitry 164 for use by the one or more processors 160 to receive input signals 166, such as control signals 168 (FIG. 1) from a central controller, issue control signals 170 (e.g., motor control signals) and/or communicate data 172, such as in response to the execution of the instructions stored in the memory 162 by the one or more processors 160.

The controller 154 may control a watering operation based on the pressure signal 152 and an angular position of the nozzle head 106 about the central axis 124, such as in response to the execution of instructions stored in the memory 162 or other memory. The angular position of the nozzle head 106 may be determined, for example, using an encoder that is connected to the drive mechanism 120.

In one example, the controller 154 may start a watering operation by opening the valve 140 using the motor 146. A mapping stored in the memory 162 may link the angular position of the nozzle head to a desired pressure, which corresponds to a desired flow rate of the water flow 114 and a distance the water streams 118 are discharged from the nozzle head 106 such that they reach a perimeter boundary of a predefined watering area, for example. Thus, the controller 154 may adjust the position or state of the valve 140 using the motor 146 based on the pressure signal 152 until the corresponding value matches the desired pressure for the angular position of the nozzle head 106. The process may continue for different angular positions of the nozzle head 106 to perform a watering operation over the predefined watering area.

Each time the riser of a conventional sprinkler moves between its raised and lowered positions, but particularly when the riser moves from the raised position to the lowered position, sand, dirt, or other debris from the surrounding soil may move into a gap between the riser and the below-grade portion of the sprinkler housing. The debris may accumulate over time and cause the riser to bind or stick to the housing, preventing the riser from fully retracting or extending. This may create a potential safety hazard, cause mechanical damage, make the sprinkler susceptible to damage from contact from a lawn care vehicle (e.g., lawn mower, etc.), and/or compromise the sprinkler's performance.

Embodiments of the sprinkler 100 include features that operate to prevent the riser 130 from binding by flushing debris from alongside the riser 130 and/or preventing debris from entering a gap between the riser 130 and the sprinkler housing 102 and/or the rotatable support 136. This flushing operation occurs during movement of the riser post between the lowered position and the raised position, but is particularly effective at preventing debris from entering the housing 102 alongside the riser 130 when the riser 130 is transitioned from the raised position to the lowered position.

In some embodiments, the flushing feature of the sprinkler 100 is facilitated by the design of the riser 130 and an annular guide 180 located at a distal end 182 of the pedestal 132. The annular guide 182 defines a post opening 184 through which the riser 130 extends. The riser 130 includes the water receiver 144 at a proximal end 186 at which at least a portion 188 of the water flow 114 is received, as shown in FIG. 4. A tubular section 190 of the riser 130 extends from the water receiver 144 along the central axis 124 and supports the nozzle head 106 or one or more nozzles 108 at a distal end 192.

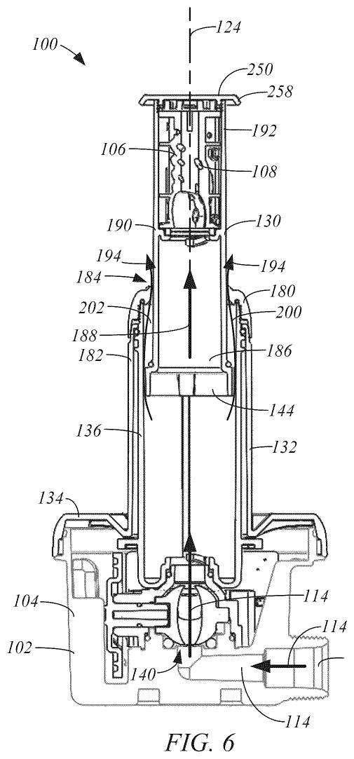

When the valve 140 is opened, the water flow 114 travels through the valve 140 and the portion 188 enters the water receiver 144. This drives movement of the riser 130 from the lowered position (FIG. 4) along the central axis 124 to the raised position, such as shown in FIG. 3 and the side cross-sectional view of FIG. 6. When the water flow 114 through the valve 140 is terminated, the riser 130 moves from the raised position to the lowered position (FIGS. 2 and 4) such as due to gravity or through the use of a spring or another suitable biasing mechanism.

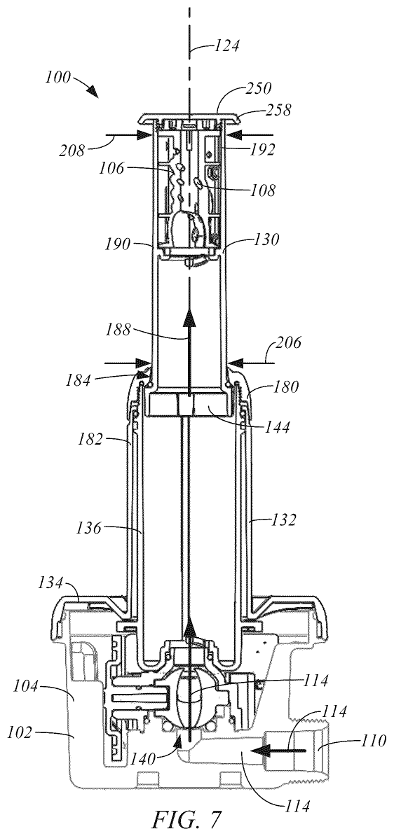

In some embodiments, during movement of the riser 130 from the raised position to the lowered position, but also during movement from the lowered position to the raised position, a portion 194 of the water flow 114 is driven through the post opening 184 between the annular guide 180 and the riser 130, as indicated in the side cross-sectional view of FIG. 7, to flush debris away from the riser 130. The water flow 194 may be a portion of the water flow 114 delivered through the valve 140, such as while the riser is transitioned from the lowered position to the raised position, or the water flow 194 may be generated by the lowering of the riser 130 along the central axis 124 relative to the annular guide 180 toward the lowered position in response to the closing of the valve 140, for example. In some embodiments, the valve 140 may remain slightly open during the transition of the riser 130 from the raised position to the lowered position, such that a small water flow 114 travels through the valve 140 to facilitate flushing of the sprinkler 100, as discussed below.

Some embodiments of this flushing feature of the sprinkler 100 will be described with reference to FIGS. 8-10, which are a partial cross-sectional view of the sprinkler 100 near the annular guide 180, a close-up view of FIG. 8 taken within circle 9, and a close-up view of FIG. 8 taken within circle 10, respectively, in accordance with embodiments of the present disclosure.

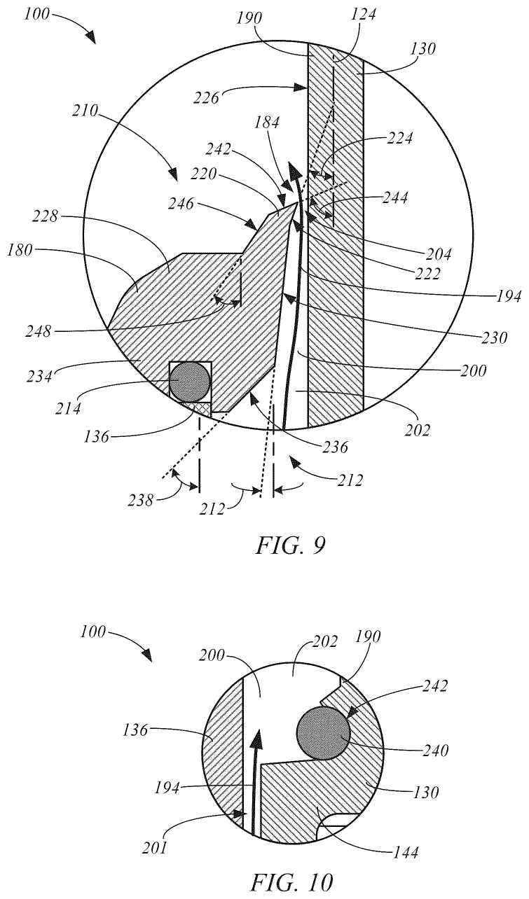

In some embodiments, the water flow 194 travels through a sprinkler flush pathway 200 extending from a gap 201 (FIG. 10) between the water receiver 144 and the rotatable support 136, through an annular cavity 202 between the tubular section 190 and the rotatable support 136, and through a gap 204 (FIG. 9) at the post opening 184 between the tubular section 190 and the annular guide 180. In some embodiments, the gap 204 between the annular guide 180 and the riser 130 decreases as the riser 130 moves along the central axis 124 relative to the annular guide 180 from the lowered position to the raised position or increases as the riser 130 moves along the central axis 124 relative to the annular guide 180 from the raised position to the lowered position. While the gap 204 is present, the water flow 194 operates to flush any debris located within cavity 202 through the post opening 184 and wash any debris off the tubular section 190 near the post opening 184. In one embodiment, this variable gap is formed by tapering the diameter of the tubular section 190 from a diameter 206 near the water receiver 144 at the proximal end 186 down to a diameter 208 near the distal end 192 of the riser 130, as shown in FIG. 7. That is, the diameter 208 is smaller than the diameter 206.

In one embodiment, the annular guide 180 includes a top side 210 and a bottom side 212 that is displaced from the top side 210 along the central axis 124. The bottom side 212 of the annular guide 180 may be attached to the rotatable support 136, such as through a threaded connection. An O-ring 214 may form a seal between the rotatable support 136 and the annular guide 180.

In some embodiments, the annular guide 180 includes a deflector 220 at the top side 210 that defines the minimum diameter of the post opening 184. In some embodiments, the diameter of the post opening 184 increases with displacement along the central axis 124 toward the bottom side 212 of the annular guide 180. That is a radial distance from the central axis to the annular guide 180 increases with displacement from the deflector 220 toward the bottom side 212, such as shown in FIG. 9.

In some embodiments, the deflector 220 includes an interior surface 222 that is oriented at an acute angle 224 relative to the central axis 124, as shown in FIG. 9. The gap 204 is generally defined by the interior surface 222 and an exterior surface 226 of the tubular section 190. The interior surface 222 generally operates as a nozzle that discharges the water flow 194 through the gap 204 and the post opening 184 and against the exterior surface 226 of the riser 130 at a sufficiently high velocity to remove debris from the tubular section 190 as the riser 130 moves toward the lowered position.

The annular guide 180 may include a central portion 228 between the deflector 220 and the bottom side 212 having an interior surface 230 that is oriented at an acute angle 232 relative to the central axis 124 that is less than the acute angle 224 of the interior surface 222, as shown in FIG. 9. The interior surface 230 of the central portion generally operates to collect and feed the water flow 194 along the sprinkler flush pathway 200 toward the interior surface 222 of the deflector 220 and the gap 204.

The annular guide 180 may also include a bottom portion 234 having an interior surface 236 that is oriented at an acute angle 238 relative to the central axis 124 that is greater than the angle 232 of the interior surface 230 of the central portion 228. The interior surface 236 also facilitates collecting the water flow 194 and directing it through the pathway 200 and toward the central portion 228 and the deflector 220.

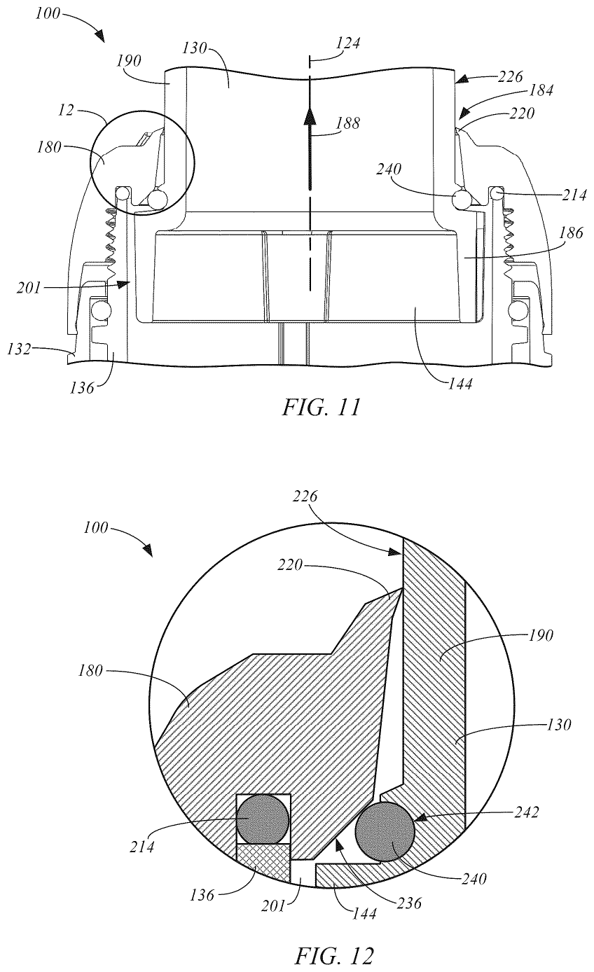

In some embodiments, the sprinkler 100 closes or seals the fluid pathway 200 when the riser 130 is in the raised position (FIG. 6). One example of this sealing feature is shown in FIGS. 11 and 12. FIG. 11 is a partial cross-sectional view of the sprinkler 100 near the annular guide 180 when the riser 130 is in the fully raised position and FIG. 12 is a simplified close-up view of the sprinkler of FIG. 11 taken within circle 12, in accordance with embodiments of the present disclosure.

In the illustrated example, the sprinkler 100 includes an O-ring 240 that is supported on the riser 130 at a junction between the tubular section 190 and the water receiver 144, as shown in FIG. 12. In some embodiments, the O-ring 240 is received within an annular grove 242 of riser 130 to secure its position relative to the riser 130. When the riser 130 reaches the raised position, the O-ring 240 engages and forms a seal with the bottom side 212 of the annular guide 180, such as the interior surface 236, as shown in FIG. 12. This seals or closes the fluid pathway 200 and the cavity 202 and prevents debris from entering the cavity 202 during a watering operation.

Embodiments of the annular guide 180 also operate to direct debris away from the post opening 184. For example, in some embodiments, the deflector 220 includes a top exterior surface 242 that is oriented at an acute angle 244 relative to the central axis 124, as shown in FIG. 9. The top exterior surface 242 operates to deflect material or debris away from the tubular section 190 and the central axis 124 as the riser 130 moves from the raised position toward the lowered position.

In some embodiments, the central portion 228 of the annular guide 180 includes an exterior surface 246 that extends from the top exterior surface 242 and is oriented at an acute angle 248 relative to the central axis 124 that is less than the acute angle 244 of the top exterior surface 242, as shown in FIG. 9. The exterior surface 246 is configured to deflect material or debris received from (e.g., flowing off) the top exterior surface 242 away from the tubular section 190 and the central axis 124.

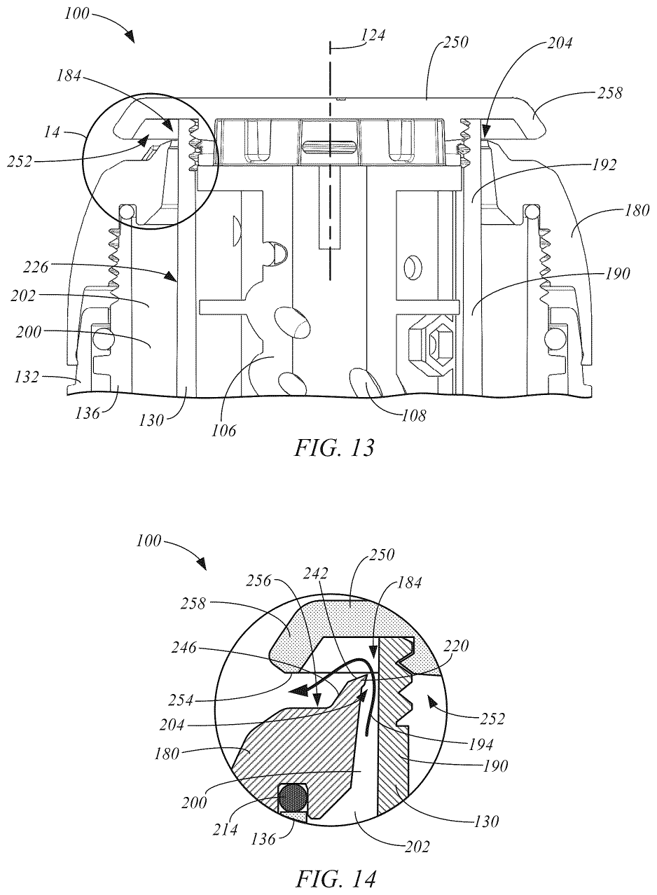

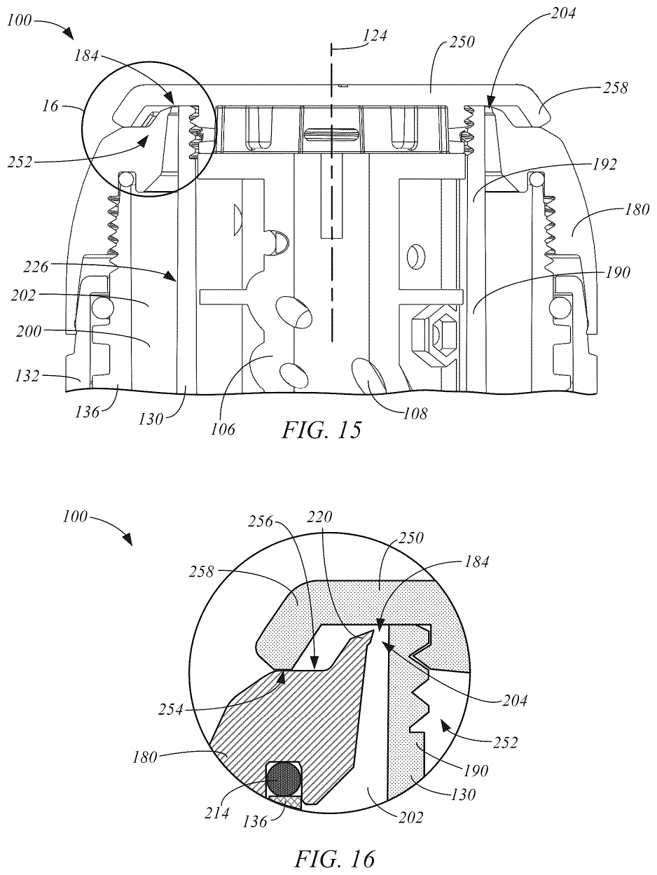

Additional embodiments of the sprinkler 100 relate to the manner in which the post opening 184 is closed or sealed when the riser 130 is moved to the lowered position. FIG. 13 is a partial cross-sectional view of the sprinkler 100 near the annular guide 180 when the riser 130 is near the lowered position and FIG. 14 is a close-up view of FIG. 13 taken within circle 14, in accordance with embodiments of the present disclosure. FIG. 15 is a partial cross-sectional view of the sprinkler 100 near the annular guide 180 when the riser 130 is in the lowered position and FIG. 16 is a close-up view of FIG. 15 taken within circle 16, in accordance with embodiments of the present disclosure.

In some embodiments, the riser 130 includes a cap 250 at the distal end 192 that extends radially from the central axis 124 and covers the post opening 184 and the deflector 220 of the annular guide 180 when the riser 130 is in the lowered position, as shown in FIG. 15.

As the riser 130 is moved toward the lowered position, the water flow 194 travels through the fluid pathway 200 past the deflector 220 and through the post opening 184, as shown in FIG. 14. A bottom side 252 of the cap 250 directs the water flow 194 along the surfaces of the deflector 220 and away from the tubular section 190 and the central axis 124, as indicated in FIG. 14. This flushes debris off and away from the exterior surface 226 of the tubular section 190 and exterior surfaces of the annular guide 180, such as surfaces 242 and 246.

In one embodiment, a bottom surface 254 of the cap 250 engages an exterior surface on the top side 210 of the annular guide 180, such as surface 256, when the riser 130 is in the lowered position, as shown in FIG. 16. This blocks debris from entering the post opening 184.

In some embodiments, a perimeter portion 258 of the cap extends in a downward direction along the central axis 124 toward the annular guide 180 and includes the bottom surface 254, as shown in FIG. 16. In one embodiment, the bottom surface 254 engages the exterior of the annular guide 180 at a location that is displaced along the central axis 124 toward the bottom side 212 of the annular guide 180 from the post opening 184. As a result, the seal formed between the bottom surface 254 of the cap 250 and the annular guide 180 is located below the post opening 184, as shown in FIG. 16.

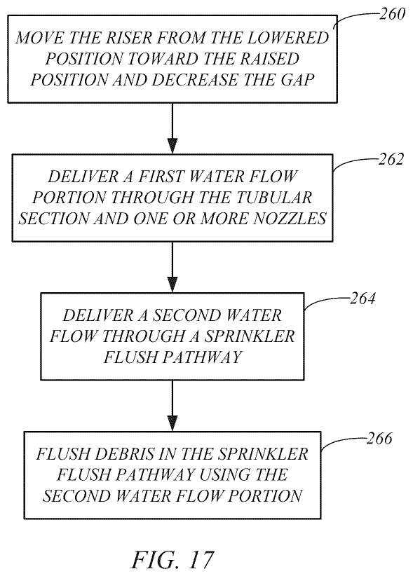

Additional embodiments relate to methods of operating the sprinkler 100, which is formed in accordance with one or more embodiments described herein, including flushing the sprinkler 100. FIG. 17 is a flowchart illustrating an example of the method, in accordance with embodiments of the present disclosure. At 260 of the method, the riser 130 is moved from the lowered position (FIGS. 4 and 15) toward the raised position (FIG. 6), which decreases the gap 204 extending through the post opening 184 between the tubular section 190 and the annular guide 180. This movement of the riser 130 is driven by a water flow 114 or 188 that is received at the water receiver 144 of the riser post 130. In one embodiment, the gap 204 decreases during step 160 due to the diameter of the tubular section 190 being tapered from the diameter 208 at the distal end 192 to the diameter 206 at the proximal end 186 that is larger than the diameter 208.

At 262 of the method, a first water flow portion 188 of the water flow 114 is delivered through the tubular section 190 to one or more nozzles 108, where it is discharged water streams 118 (FIG. 1).

At 264 of the method, a second water flow portion 194 of the water flow 114 is delivered through the sprinkler flush pathway 200. In one embodiment, the sprinkler flush pathway 200 travels through a gap 201 between the water receiver 144 of the riser 130 and the rotatable support 136 or sprinkler housing 102, through the cavity 202 between the rotatable support 136 or the housing 102 and the tubular section 190, and through a gap 204 between the annular guide 180 and the tubular section 190 of the riser 130.

At 266 of the method, debris in the sprinkler flush pathway 200 is flushed through the gap 204 and the post opening 184 using the second water flow portion 194.

In some embodiments of the method, the sprinkler flush pathway 200 is closed using a seal formed between a bottom portion 234 of the annular guide 180 and an O-ring 242 supported on the riser 130 at a junction between the tubular section 190 and the water receiver 144, as discussed above with reference to FIG. 12.

In some embodiments of the method, the flow rate of the water flow 114 is reduced, which causes the riser 130 to move toward the lowered position. Debris and water is then deflected away from the tubular section 190 and the central axis 124 at the top side 210 of the annular guide 180, such as at the top exterior surface 242 of the deflector 220 and the exterior surface 246, during the movement of the riser 130, as discussed above.

Accordingly, the method operates to flush debris away from the tubular section 190 and prevent debris from entering the cavity 202 between the rotatable support 136 and the tubular section 190 of the riser 130. As a result, the method prevents binding of the riser 130 due to debris getting between the tubular section 190 and the sprinkler housing 102 or the rotatable support 136.

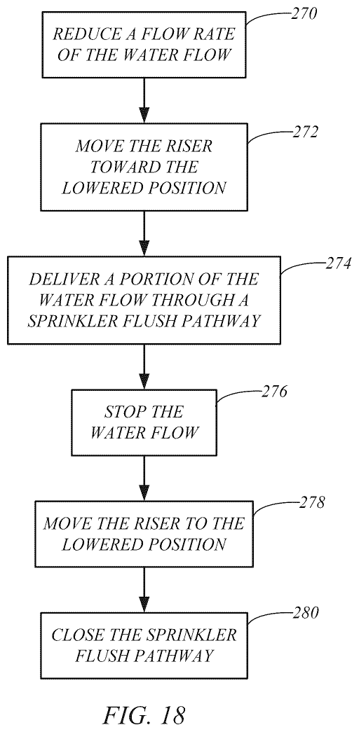

FIG. 18 is a flowchart illustrating an example of a method of operating the irrigation sprinkler 100, in accordance with embodiments of the present disclosure. At 270 of the method, the flow rate of the water flow 114 is reduced and, at 272, the riser 130 moves toward the lowered position in response to the reduced water flow 114. In one embodiment, the reduction in the rate of the water flow 114 includes terminating the water flow 114 using the valve 140 or reducing the water flow 114 to a non-zero flow rate. This may, for example, lower the riser 130 to the near-lowered position shown in FIGS. 13 and 14.

At 274 of the method, a water flow portion 194 of the water flow 114 is delivered through the sprinkler flush pathway 200, which extends between the deflector 220 of the annular guide 180 and a cap 250 that is attached to the distal end 192 of the riser 130, as shown in FIG. 14. Thus, the water flow portion 194 flushes debris off the tubular section 190 and flushes debris from the in the cavity 202 and pathway 200 through the post opening 184 during step 274.

In some embodiments of the method, the water flow 114 is stopped by closing the valve 140, as indicated at 276. At 278 of the method, the riser 130 is moved to the lowered position in response to the terminated water flow 114, such as shown in FIGS. 15 and 16. During this final movement of the riser 130 just before it reaches the lowered position, the water flow 194 continues to pass through the gap 204 and flush any debris away from the riser 130 and the annular guide 180.

At 280 of the method, the sprinkler flush pathway 200 is closed through a seal formed between the bottom surface 254 of the cap 250 and an exterior surface of the annular guide 180, such as the surface 256, as shown in FIG. 16, for example.

Accordingly, as with the method of FIG. 17, the method of FIG. 18 operates to flush debris away from the tubular section 190 and prevent debris from entering the cavity 202 between the rotatable support 136 and the tubular section 190 of the riser 130. As a result, the method prevents binding of the riser 130 by the flushing of debris from the sprinkler flush pathway 200.

Although the present invention has been described with reference to preferred embodiments, workers skilled in the art will recognize that changes may be made in form and detail without departing from the spirit and scope of the invention.

What is claimed is:

1. An irrigation sprinkler comprising:
a housing including:
a base having a water input port; and
a pedestal having a central axis and including a proximal end attached to the base and a distal end comprising an annular guide having a post opening; and
a riser configured to move along the central axis between a lowered position and a raised position relative to the pedestal and extend through the post
opening, the riser comprising:
a water receiver at a proximal end of the riser;
a tubular section extending along the central axis between the water receiver and a distal end of the riser; and
one or more nozzles supported at the distal end of the riser,
wherein:
a first gap extending through the post opening between the tubular section and the annular guide decreases as the riser moves along the central axis through the post opening from the lowered position toward the raised position; and
a fluid pathway extends from the water input port of the base through the first gap as the riser moves between the lowered position toward the raised position.

2. The irrigation sprinkler according to claim 1, wherein the tubular section has a diameter that tapers from a first diameter near the water receiver to a second diameter near the distal end that is smaller than the first diameter.

3. The irrigation sprinkler according to claim 2, wherein:
the sprinkler includes a rotatable support that is configured to rotate about the central axis relative to the base;
the riser rotates about the central axis with the rotatable support;
the water receiver of the riser slides within the rotatable support along the central axis as the riser moves between the lowered and raised positions; and
the fluid pathway extends through a second gap between the water receiver and the rotatable support.

4. The irrigation sprinkler according to claim 2, wherein:
the annular guide includes a top side and a bottom side;
the post opening extends from the top side to the bottom side;
a deflector at the top side defines a minimum diameter of the post opening; and
a diameter of the post opening increases with displacement along the central axis toward the bottom side from the deflector.

5. The irrigation sprinkler according to claim 4, wherein:
the sprinkler includes an O-ring that is supported on the riser at a junction between the tubular section and the water receiver; and
the O-ring is configured to form a seal with a bottom portion at the bottom side of the annular guide when the riser is in the raised position that closes the fluid pathway.

6. The irrigation sprinkler according to claim 4, wherein:
the deflector includes an interior surface oriented at a first acute angle relative to the central axis and a top surface;
the first gap is defined by the interior surface of the deflector and an exterior surface of the tubular section; and
the annular guide includes a central portion between the deflector and the bottom side having an interior surface oriented at a second acute angle relative to the central axis that is less than the first acute angle.

7. The irrigation sprinkler according to claim 6, wherein the deflector includes a top exterior surface oriented at a third acute angle relative to the central axis configured to deflect material away from the tubular section and the central axis as the riser moves from the raised position toward the lowered position.

8. The irrigation sprinkler according to claim 7, wherein the central portion includes an exterior surface extending from the top exterior surface of the deflector and oriented at a fourth acute angle relative to the central axis, which is less than the third acute angle, the exterior surface of the central portion configured to deflect material received from the top exterior surface away from the tubular section and the central axis.

9. The irrigation sprinkler according to claim 5, wherein:
the riser includes a cap at the distal end that extends radially from the central axis;
the cap covers the post opening and the deflector when the riser is in the lowered position; and
a bottom surface of the cap engages an exterior surface of the annular guide at a location that is displaced radially from the central axis a distance that is greater than a distance from the central axis to the deflector when the riser is in the lowered position.

10. The irrigation sprinkler according to claim 9, wherein the location at which the bottom surface of the cap engages the exterior surface of the annular guide is displaced along the central axis toward the annular guide from the post opening.

11. A method of operating an irrigation sprinkler, which comprises:
a housing including:
a base having a water input port; and
a pedestal having a central axis and including a proximal end attached to the base and a distal end comprising an annular guide having a post opening; and
a riser configured to move along the central axis between a lowered position and a raised position relative to the pedestal and extend through the post opening, the riser comprising:
a water receiver at a proximal end of the riser;
a tubular section extending along the central axis between the water receiver and a distal end of the riser; and
one or more nozzles supported at the distal end of the riser,
wherein a gap extending through the post opening between the tubular section and the annular guide decreases as the riser moves along the central axis through the post opening from the lowered position toward the raised position,
the method comprising:
moving the riser from the lowered position toward the raised position and increasing the gap in response to receiving a water flow at the water receiver from the water input port;
delivering a first water flow portion of the water flow through the tubular section and the one or more nozzles;
delivering a second water flow portion of the water flow through a sprinkler flush pathway that extends between the tubular section and the pedestal and through the gap during moving the riser; and
flushing debris in the sprinkler flush pathway through the post opening using the second water flow portion.

12. The method according to claim 11, wherein the tubular section has a diameter that tapers from a first diameter near the water receiver to a second diameter near the distal end that is smaller than the first diameter.

13. The method according to claim 12, wherein:
the annular guide includes a top side and a bottom side;
the post opening extends from the top side to the bottom side;
a deflector at the top side of the annular guide defines a minimum diameter of the post opening;
a diameter of the post opening increases with displacement along the central axis toward the bottom side from the deflector; and
the method includes narrowing the gap in response to moving the riser.

14. The method according to claim 13, wherein:
the sprinkler includes an O-ring that is supported on the riser at a junction between the tubular section and the water receiver; and
the method includes closing the sprinkler flush pathway through a seal formed between a bottom portion of the annular guide and the O-ring when the riser reaches the raised position.

15. The method according to claim 13, wherein:
the deflector includes an interior surface oriented at a first acute angle relative to the central axis and a top surface;
the gap is defined by the interior surface of the deflector and an exterior surface of the tubular section; and
the annular guide includes a central portion between the deflector and the bottom side having an interior surface oriented at a second acute angle relative to the central axis that is less than the first acute angle.

16. The method according to claim 15, wherein:
the deflector includes a top exterior surface oriented at a third acute angle relative to the central axis; and
the method includes:
reducing a flow rate of the water flow;
moving the riser toward the lowered position; and
deflecting debris and water away from the tubular section and the central axis at the top exterior surface of the deflector during moving the riser toward the lowered position.

17. The method according to claim 16, wherein:
the central portion of the annular guide includes an exterior surface extending from the top exterior surface of the deflector and oriented at a fourth acute angle relative to the central axis, which is less than the third acute angle; and
the method includes deflecting debris and water away from the tubular section and the central axis at the exterior surface of the central portion during moving the riser toward the lowered position.

18. The method according to claim 13, wherein:
the riser includes a cap at the distal end that extends radially from the central axis;
the cap covers the post opening and the deflector when the riser is in the lowered position; and
a bottom surface of the cap engages an exterior surface of the annular guide when the riser is in the lowered position at a location that is displaced along the central axis toward the annular guide from the post opening and displaced radially from the central axis a distance that is greater than a distance from the central axis to the deflector.

19. A method of operating an irrigation sprinkler, which comprises:
a housing including:
a base having a water input port; and
a pedestal having a central axis and including a proximal end attached to the base and a distal end comprising an annular guide having a post opening; and
a riser configured to move along the central axis between a lowered position and a raised position relative to the pedestal and extend through the post opening, the riser comprising:
a water receiver at a proximal end of the riser;
a tubular section extending along the central axis between the water receiver and a distal end of the riser; and
one or more nozzles supported at the distal end of the riser,
wherein a gap extending through the post opening between the tubular section and the annular guide increases as the riser moves along the central axis through the post opening from the raised position toward the lowered position,
the method comprising:
moving the riser from the raised position toward the lowered position and increasing the gap in response to decreasing a water flow received at the water receiver from the water input port;
delivering a portion of the water flow through a sprinkler flush pathway that extends between the tubular section and the pedestal and through the gap during moving the riser; and
flushing debris in the sprinkler flush pathway through the post opening using the portion of the water flow.

20. The method according to claim 19, wherein:
the riser includes a cap at the distal end that extends radially from the central axis;
the cap covers the post opening and the deflector when the riser is in the lowered position; and
the method includes:
stopping the water flow;
moving the riser to the lowered position in response to stopping the water flow; and
closing the sprinkler flush pathway comprising engaging an exterior surface of the annular guide with a bottom surface of the cap at a location that is:
displaced along the central axis toward the annular guide from the post opening; and
displaced radially from the central axis a distance that is greater than a distance from the central axis to the deflector.
